(19) United States
(12) Patent Application Publication
(10) Pub. No.: US 2014/0354607 A1
(43) Pub. Date: Dec. 4, 2014

(54) LIQUID CRYSTAL DISPLAY

(71) Applicant: HON HAI PRECISION INDUSTRY CO., LTD., New Taipei (TW)

(72) Inventor: YI-ZHONG SHEU, New Taipei (TW)

(73) Assignee: HON HAI PRECISION INDUSTRY CO., LTD., New Taipei (TW)

(21) Appl. No.: 13/975,600

(22) Filed: Aug. 26, 2013

(30) Foreign Application Priority Data
May 30, 2013 (TW) 102119095

(51) Int. Cl. G09G 3/36

(52) U.S. Cl. CPC G09G 3/3611
USPC 345/204

(57) ABSTRACT

A liquid crystal display includes an image processor, a first electrical-optical converter, a second electrical-optical converter, an optical signal transmission element, a time controlling unit, a number of source driving units, a gate driving unit, and a display panel. The image processor converts a number of frames of image data into an image electrical signal. The first electrical-optical converter converts the image electrical signal to an image optical signal. The optical signal transmission element transmits the image optical signal to the second electrical-optical converter. The second electrical-optical converter converts the image optical signal to the image electrical signal. The time controlling unit transmits the image electrical signal to the source driving units, and outputs a controlling electrical signal to the gate driving unit. The source driving units and the gate driving unit cooperatively display the frames of image data on the display panel sequentially.

### BACKGROUND

1. Technical Field

The present disclosure relates to a liquid crystal display.

2. Description of Related Art

Liquid crystal displays use copper wires to transmit electrical signals. When the copper wires transmit signals, a number of electromagnetic waves which could pick up interference from other surrounding electromagnetic waves are generated. Thus the quality of the electrical signals is reduced.

Therefore, it is desirable to provide a liquid crystal display that can overcome or at least alleviate the above-mentioned limitations.

### BRIEF DESCRIPTION OF THE DRAWINGS

Many aspects of the embodiments should be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic view of a liquid crystal display, according to a first exemplary embodiment.

FIG. 2 is a schematic view of a liquid crystal display, according to a second exemplary embodiment.

### DETAILED DESCRIPTION

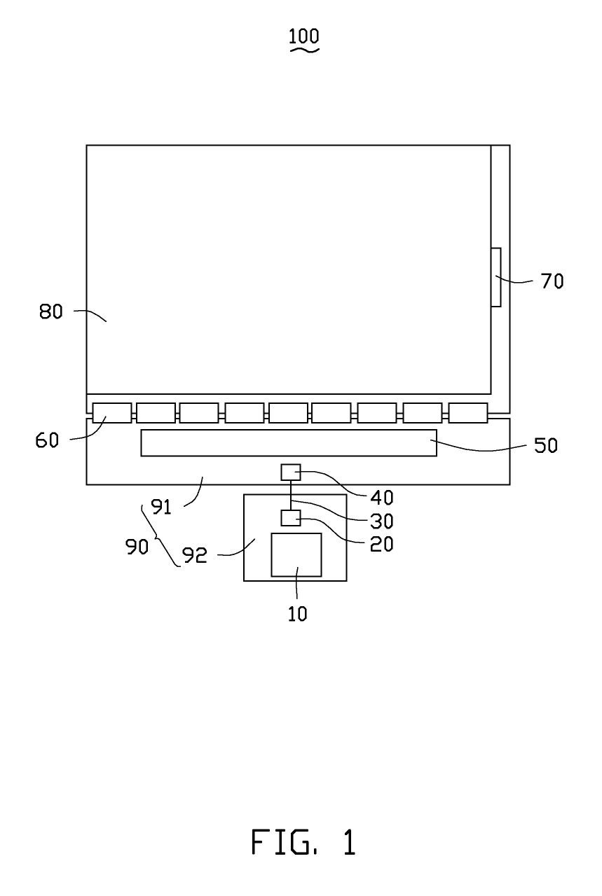

FIG. 1 illustrates a liquid crystal display 100 in accordance to a first exemplary embodiment. The liquid crystal display 100 includes an image processor 10, a first optical-electrical converter 20, an optical signal transmission element 30, a second optical-electrical converter 40, a time controlling unit 50, a number of source driving units 60, a gate driving unit 70, a display panel 80, and a controlling circuit board 90.

The image processor 10 is used for converting a number of frames of image data into an image electrical signal. The image electrical signal may be a digital signal or an analog signal.

The first optical-electrical converter 20 is used for receiving the image electrical signal, and converting the image electrical signal into an image optical signal.

The optical signal transmission element 30 is used for transmitting the image optical signal to the second optical-electrical converter 40. The optical signal transmission element 30 can include an optical fiber.

The second optical-electrical converter 40 is used for receiving the image optical signal, and converting the image optical signal to the image electrical signal.

The time controlling unit 50 is electrically connected to the source driving unit 60 and the gate driving unit 70, and is used for receiving the image electrical signal, transmitting the image electrical signal to the source driving units 60, and outputting a controlling electrical signal to the gate driving unit 70. Thus the source driving unit 60 and the gate driving unit 70 cooperatively display the frames of image data on the display panel 80 sequentially. The time controlling unit 50 can include a time controller, and the gate driving unit can include at least one gate driver.

The controlling circuit board 90 includes a first portion 91 and a second portion 92. The source driving units 60, the time controlling unit 50, and the second optical-electrical converter 40 are fixed to the first portion 91. The first optical-electrical converter 20 and the image processor 10 are fixed to the second portion 92.

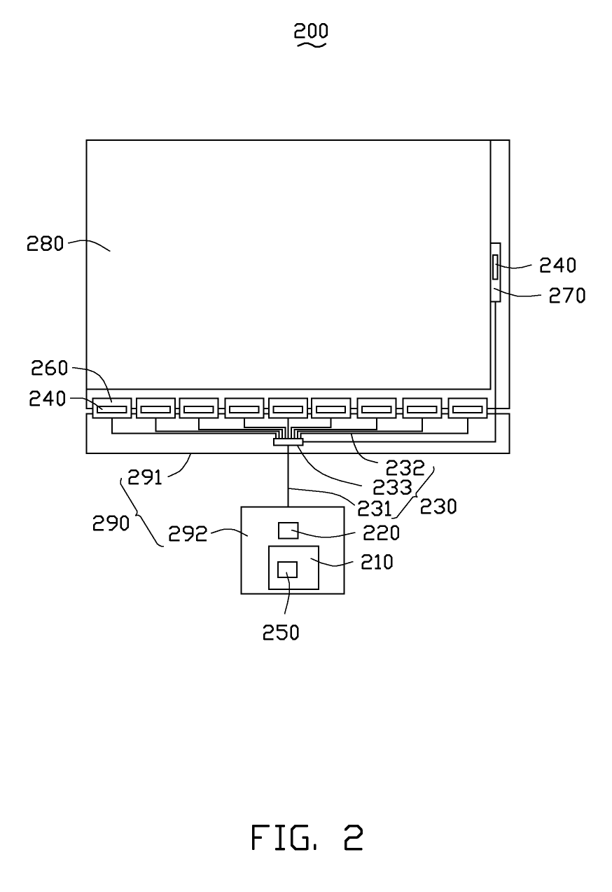

FIG. 2 illustrates a liquid crystal display 200 in accordance to a second exemplary embodiment. The liquid crystal display 200 includes an image processor 210, a first optical-electrical converter 220, an optical signal transmission element 230, a number of second optical-electrical converters 240, a time controlling unit 250, a number of sources driving unit 260, a gate driving unit 270, a display panel 280, and a controlling circuit 290.

The difference between the liquid crystal display 200 and the liquid crystal display 100 is that the time controlling unit 250 is integrated with the image processor 210. The time controlling unit 250 adds a controlling electrical signal to the image electrical signal from the image processor 210 to obtain a composite electrical signal. The first optical-electrical converter 220 converts the composite electrical signal to a first composite optical signal. In this embodiment, the image electrical signal is a current signal, and the controlling signal is a voltage signal.

The number of the second optical-electrical converters 240 is substantially equal to the sum of the number of the source driving units 260 and the number of the gate driving unit 270. One of the second optical-electrical converters 240 corresponds to the gate driving unit 270, and is integrated with the gate driving unit 270. The other second optical-electrical converters 240 correspond to the source driving units 260 respectively, and are integrated with the corresponding source driving units 260.

The optical signal transmission element 230 includes a first optical fiber 231, a light splitter 233, and a number of second optical fibers 232. The first optical fiber 231 transmits the first composite optical signal to the light splitter 233. The light splitter 233 converts the first composite optical signal to a number of same second composite optical signals. The second optical fibers 232 transmit the second composite optical signals to the second optical-electrical converters 240 respectively. Each of the second optical-electrical converters 240 converts the corresponding second composite optical signal to a second composite electrical signal. The source driving units 260 and the gate unit 270 receive the corresponding second composite electrical signals, the source driving units 260 and the gate driving unit 270 cooperatively display the frames of image data on the display panel 280 sequentially.

The controlling circuit board 290 includes a first portion 291 and a second portion 292. The first portion 291 fixes the second optical fibers 232, the light splitter 233, the second optical-electrical converters 240, and the source driving units 260. The second portion 292 fixes the first optical-electrical converter 220, the time controlling unit 250, and the image processor 210.

By employing the liquid crystal display of the present disclosure, the electrical signal is converted to the optical signal to be transmitted. During the transmitting process of the optical signal, no electromagnetic wave is generated, and the optical signal cannot be affected or just slightly affected by other electromagnetic waves. Therefore, the signal quality can be effectively improved.

It will be understood that the above particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A liquid crystal display comprising:
an image processor configured for converting a plurality of frames of image data to into an image electrical signal;
a first electrical-optical converter configured for converting the image electrical signal to an image optical signal;
a second electrical-optical converter configured for converting the image optical signal to the image electrical signal;
an optical signal transmission element configured for transmitting the image optical signal to the second electrical-optical converter;
a plurality of source driving units;
a gate driving unit;
a time controlling unit configured for transmitting the image electrical signal to the source driving units, and outputting a controlling electrical signal to the gate driving unit; and
a display panel;
wherein the source driving units and the gate driving unit cooperate to display the frames of image data on the display panel sequentially.

2. The liquid crystal display of claim 1, further comprising a controlling circuit board, wherein the controlling circuit board comprises a first portion and a second portion, the first portion is configured for fixing the source driving units, the time controlling unit, and the second optical-electrical converter, the second portion is configured for fixing the first optical-electrical converter and the image processor.

3. The liquid crystal display of claim 1, wherein the optical signal transmission element comprises an optical fiber.

4. The liquid crystal display of claim 1, wherein the time controlling unit comprises at least one time controller.

5. The liquid crystal display of claim 1, wherein the gate driving unit comprises at least one gate driver.

6. A liquid crystal display comprising:
an image processor configured for converting a plurality of frames of image data into an image electrical signal;
a time controlling unit configured for adding a controlling signal to the image electrical signal to obtain a first composite electrical signal;
a first electrical-optical converter configured for converting the first composite electrical signal to a first composite optical signal;
a plurality of second electrical-optical converters;
an optical signal transmission element configured for splitting the first composite optical signal to a plurality of same second composite optical signals, and transmitting the second composite optical signals to the second electrical-optical converters, wherein the second electrical-optical converters are configured for converting the corresponding second composite optical signal to a second composite electrical signal;
a gate driving unit corresponding to one of the second electrical-optical converters, and configured for receiving the corresponding second composite electrical signal;
a plurality of source driving units corresponding to the other of the second electrical-optical converters, and configured for receiving the corresponding second composite electrical signal; and
a display panel;
wherein the source driving units and the gate driving unit cooperate to display the frames of image data on the display panel sequentially.

7. The liquid crystal display of claim 6, wherein the time controlling unit is integrated with the image processor.

8. The liquid crystal display of claim 6, wherein the source driving units are integrated with the corresponding second electrical-optical converters respectively, and the gate driving unit is integrated with the corresponding second electrical-optical converter.

9. The liquid crystal display of claim 6, wherein the optical signal transmission element comprises a first optical fiber, a light splitter, and a plurality of second optical fibers, the first optical fiber is configured for transmitting the first composite optical signal to the light splitter, the light splitter is configured for splitting the first composite optical signal to the second composite optical signals, and the second optical fibers are configured for transmitting the second composite optical signals to the source driving units and the gate driving unit respectively.

10. The liquid crystal display of claim 6, wherein the controlling circuit board includes a first portion and a second portion, the first portion is configured for fixing the second optical fibers, the light splitter, the second optical-electrical converters, and a source driving unit, the second portion is configured for fixing the first optical-electrical converter, the time controlling unit, and the image processor.

11. The liquid crystal display of claim 6, wherein the time controlling unit comprises at least one time controller.

12. The liquid crystal display of claim 6, wherein the gate driving unit comprises at least one gate driver.
